(19) United States
(12) Patent Application Publication
(10) Pub. No.: US 2005/0076534 A1
(43) Pub. Date: Apr. 14, 2005

(54) Fabric article treating device and system with static control

(76) Inventors: Kofi Ofosu-Asante, Cincinnati, OH (US); Dean Larry DuVal, Lebanon, OH (US)

Correspondence Address: The Procter & Gamble Company;IP Division Central Docketing, WHBC - FC Box 161, 6110 Center Hill Avenue, Cincinnati, OH, 45224, US

(21) Appl. No.: 10/927,212

(22) Filed: Aug. 26, 2004

Related U.S. Application Data
(63) Continuation-in-part of application No. 10/842,926, filed on May 11, 2004.
Application No. 10/842,926 is a continuation-in-part of application No. 10/839,549, filed on May 5, 2004.
Application No. 10/839,549 is a continuation-in-part of application No. 10/762,152, filed on Jan. 21, 2004.
Application No. 10/762,152 is a continuation-in-part of application No. 10/697,736, filed on Oct. 29, 2003.
Application No. 10/762,152 is a continuation-in-part of application No. 10/697,734, filed on Oct. 29, 2003.
Application No. 10/762,152 is a continuation-in-part of application No. 10/697,685, filed on Oct. 29, 2003.
Application No. 10/762,152 is a continuation-in-part of application No. 10/697,735, filed on Oct. 29, 2003.
Application No. 10/697,735 is a continuation-in-part of application No. 10/418,595, filed on Apr. 17, 2003.
(60) Provisional application No. 60/568,771, filed on May 6, 2004.
(60) Provisional application No. 60/374,601, filed on Apr. 22, 2002.
(60) Provisional application No. 60/426,438, filed on Nov. 14, 2002.

(51) Int. Cl. F26B 11/02

(52) U.S. Cl. 34/597

(57) ABSTRACT

A fabric article treating device includes an interior dispenser adapted for location inside of a fabric article drying appliance, a controller and a static sensor adapted for sensing static charge inside the fabric article drying appliance. The controller is configured to initiate dispensing of anti-static agent when the static sensor senses a predetermined amount of static charge.

### CROSS REFERENCE TO RELATED APPLICATIONS

This application claims the benefit of U.S. Provisional Application Ser. No. 60/568,771 entitled “Uniform Delivery of Compositions”, filed on May 6, 2004 and is a continuation-in-part of U.S. Ser. No. 10/842,926 entitled “Fabric Article Treating System and Method”, filed on May 11, 2004; which is a continuation-in-part of U.S. Ser. No. 10/839,549 entitled “Processes and Apparatuses for Applying a Benefit Composition to One or More Fabric Articles During a Fabric Enhancement Operation”, filed on May 5, 2004; which is a continuation-in-part of U.S. Ser. No. 10/762,152, entitled “Volatile Material Delivery Method”, filed on Jan. 21, 2004; which is a continuation-in-part of U.S. Ser. No. 10/697,736, entitled “Fabric Article Treating Method and Device Comprising a Heating Means”, filed on Oct. 29, 2003; U.S. Ser. No. 10/697,734, entitled “Thermal Protection of Fabric Article Treating Device”, filed on Oct. 29, 2003; U.S. Ser. No. 10/697,685, entitled “Fabric Article Treating Device Comprising More Than One Housing”, filed on Oct. 29, 2003; and U.S. Ser. No. 10/697,735, entitled “Fabric Article Treating Apparatus with Safety Device and Controller”, filed Oct. 29, 2003; each of which is a continuation-in-part of U.S. Ser. No. 10/418,595, entitled “Fabric Article Treating Method and Apparatus”, filed on Apr. 17, 2003, which claims the benefit of U. S. Provisional Application Ser. No. 60/374,601, filed Apr. 22, 2002 and U.S. Provisional Application Ser. No. 60/426,438, filed Nov. 14, 2002.

### FIELD OF THE INVENTION

The present invention relates to a fabric article treating device for use with a fabric article drying appliance, and more specifically to a unique fabric article treating device and system advantageous for providing static control.

### BACKGROUND OF THE INVENTION

Fabric article treating methods and/or apparatuses have been evolving over the past twenty years. For example, U.S. Pat. No. 4,207,683 describes a conventional automatic clothes dryer that incorporates a spray dispenser capable of dispensing liquids into the drum of the dryer. U.S. Pat. Nos. 4,642,908, 5,771,604 and 6,067,723 describe other variations of conventional clothes drying appliances.

There exists an ongoing need to develop a fabric article treating method and/or apparatus especially an in-home fabric article treating method and/or apparatus that improves/enhances the deposition of fabric article actives or benefit agents on the fabric articles being treated as compared to the currently existing deposition methods and/or apparatuses.

One particular challenge of drying fabric articles in a tumble dryer is the development of contact electrification as the fabric articles lose moisture content and are brought into physical contact with each other. Dried fabric articles tend to accumulate static charge because they are insulators and their surfaces are non-conductive. The accumulation of static charge leads to many undesirable outcomes. First, the accumulated static charge can attract lint and dust to the fabric article. Second, an excessive accumulation of static charge can be a fire hazard in dryers. Third, discharge of the accumulated static charge can lead to operator/personnel shock. Finally and importantly, fabric articles with built up static charge are sometimes unsightly to wear and a nuisance, and can cause shocks to the person wearing the fabric article.

Compositions are known to those skilled in the art which can dissipate the static charge in fabric articles, and are often applied from a sheet or other device which is placed in a dryer with fabric articles to be dried. However, further improvements in dissipation of and/or minimizing accumulation of static charge in fabric article drying appliances are desired.

### SUMMARY OF THE INVENTION

The present invention is directed to fabric article treating devices and fabric article treating systems. More particularly, the invention is directed to fabric article treating devices having a static sensor adapted for sensing static charge and upon sensing an accumulation of the static charge dispensing an anti-static agent in the fabric article drying appliance.

One embodiment of the present invention is a fabric article treating device which comprises an interior dispenser adapted for location inside of a fabric article drying appliance, a controller and a static sensor. The static sensor is adapted for sensing static charge inside the fabric article drying appliance, and the controller is configured to initiate dispensing of anti-static agent when the static sensor senses a predetermined amount of static charge.

Another embodiment of the present invention is a fabric article treating device which comprises an interior dispenser adapted for location inside of a fabric article drying appliance and a reservoir. The reservoir is adapted to contain a benefit composition, and the interior dispenser and the reservoir are adapted for fluid communication with one another. The fabric article treating system further comprises a controller and a static sensor adapted for sensing static charge inside the fabric article drying appliance. The controller is configured to initiate dispensing of the benefit composition when the static sensor senses a predetermined amount of static charge.

A further embodiment of the present invention is a fabric article treating device which comprises an air ionizer adapted to dispense ionized air inside of a fabric article drying appliance to quench a static charge; a controller; and a static sensor adapted for sensing static charge inside the fabric article drying appliance. The controller is configured to activate the air ionizer when the static sensor senses a predetermined amount of static charge.

Another embodiment of the present invention is a fabric article treating system. The fabric article treating system comprises a fabric article drying appliance having a chamber and a closure structure, the closure structure having a closed position and at least one open position and allowing access to the chamber; a dispenser in communication with the chamber; a static sensor in the chamber; and a controller configured to initiate dispensing of anti-static agent when the static sensor senses a predetermined amount of static charge.

The present devices and systems are advantageous for providing static control, and particularly minimizing static accumulation, in a fabric article treating device.

### BRIEF DESCRIPTION OF THE DRAWINGS

While the specification concludes with claims particularly pointing out and distinctly claiming the invention, it is believed the same will be better understood from the following description taken in conjunction with the accompanying drawings in which:

FIG. 1 is a schematic illustration of an exemplary fabric article treating device according to a first embodiment of the present invention;

FIG. 2 is a schematic illustration of an exemplary fabric article treating device according to a second embodiment of the present invention;

FIG. 3 is a schematic illustration of an exemplary fabric article treating device according to a third embodiment of the present invention;

FIG. 4 is a schematic illustration of an exemplary fabric article treating device according to a fourth embodiment of the present invention;

FIG. 5 is a schematic illustration of an exemplary fabric article treating system according to a fifth embodiment of the present invention;

FIG. 6 is a schematic illustration of an exemplary fabric article treating device according to a sixth embodiment of the present invention; and

FIG. 7 is a schematic illustration of an exemplary fabric article treating system according to a seventh embodiment of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various embodiments of the invention, examples of which are illustrated in the accompanying drawings, wherein like numerals indicate similar elements throughout the views.

### Definitions

The phrase “fabric article treating system” as used herein means a fabric article drying appliance, a non-limiting example of which includes a conventional clothes dryer and/or modifications thereof. The fabric article treating system also includes a fabric article treating apparatus which may be discrete in relation to the fabric article drying appliance and/or it may be integrated into the fabric article drying appliance. Furthermore, the fabric article treating apparatus may be integrated into a readily replaceable portion of the fabric article drying appliance, a non-limiting example of which includes a closure structure of the drying appliance.

“Fabric article” or “fabric” as used herein means any article that is customarily cleaned in a conventional laundry process or in a dry cleaning process. The term encompasses articles of fabric including, but not limited to, clothing, linen, drapery, clothing accessories, leather, floor coverings, sheets, towels, rags, canvas, polymer structures, and the like. The term also encompasses other items made in whole or in part of fabric material, such as tote bags, furniture covers, tarpons, shoes, and the like.

As used herein, the term “anti-static agent” refers to any agent and/or composition which may be used to reduce static charge on or eliminate static charge from a fabric article. In one embodiment of the present invention, the anti-static agent comprises a solvent-soluble electricity conducting composition. Non-limiting examples of materials and mixtures thereof which can comprise suitable anti-static agents include: polymers such as polyanilines, polypyrroles, polyacetylene, polyphenylene and polythiophenes. Other anti-static agents which can reduce or mitigate static charge of fabric articles are generally known to one skilled in the art and are suitable for use herein. In addition, the anti-static agent may comprise ionized air which can be used to quench static electricity of a fabric article.

As used herein, the term “benefit composition” refers to a composition used to deliver a benefit to a fabric article. Non-limiting examples of materials and mixtures thereof which can comprise the benefit composition include: water, fabric softeners, superwetting agents, water absorbing agents, humectants, hueing agents, perfumes, lubricants, anti-abrasion agents, wrinkle mitigating agents, preservatives, buffering agents, pH adjusting agents, emulsion stabilizing agents, malodor control agents, oil dispersing solvents, anti-foaming agents, salt, viscosity adjusting agents, chelating agents, anti-oxidant, radical scavenging agents, soil releasing agents, anti-soiling agents, anti-bacterial agents, solvents, perfumes, crispening agents, water/stain repellants, refreshing agents, anti-microbial agents, durable press additives and combinations thereof. The benefit composition may comprise a liquid, a powder, a suspension, or gaseous product, and/or a combination of such. In one embodiment, the benefit composition includes a preservative. Various preservatives which help maintain one or more properties of the benefit composition are generally known in the art and are suitable for use herein. Exemplary preservatives include Dantoguard Plus™ (Dimethylol-5,5-Dimethylhydantoin) commercially available from Lonza; Kathon™ (isothiazolinones) commercially available from Rohm & Haas; and Integra 44™ (Sodium hydroxymethylglycinate) commercially available from International Specialty Products (ISP).

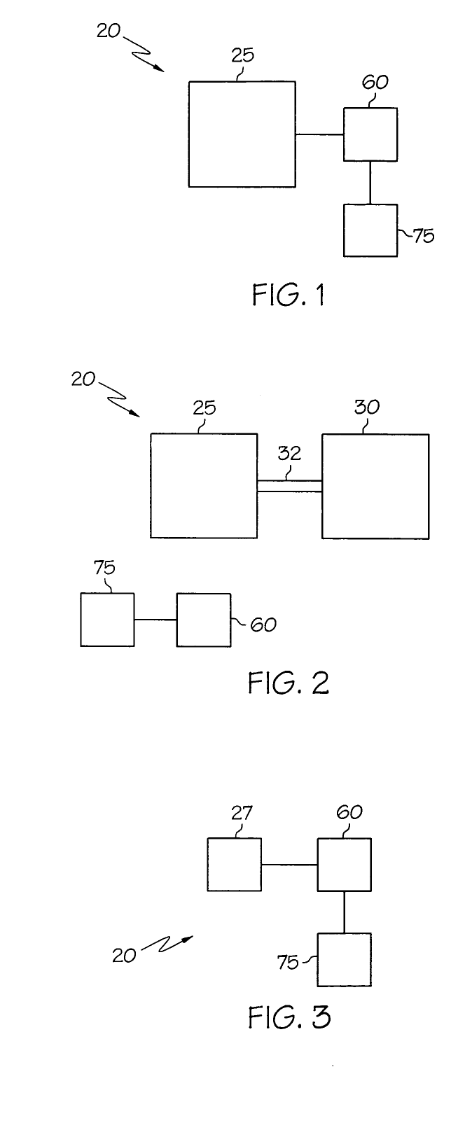

FIG. 1 illustrates an exemplary fabric article treating device 20 according to one embodiment of the present invention. The fabric article treating device 20 comprises an interior dispenser 25 adapted for location inside of a fabric article drying appliance, a controller 60 and a static sensor 75. The static sensor 75 is adapted for sensing static charge inside the fabric article drying appliance. In one embodiment, the static sensor 75 is adapted for sensing static charge by contacting the fabric article. Alternatively, in another embodiment, the static sensor 75 is adapted for sensing static charge remotely without contacting the fabric articles. The controller 60 is configured to initiate dispensing of anti-static agent when the static sensor 75 senses a predetermined amount of static charge. In one embodiment, the controller 60 and the static sensor 75 are in electrical communication with each other.

In one exemplary embodiment, the static sensor 75 comprises a capacitive sensor. Exemplary remote triboelectric charge sensors can be sourced from Monroe Electronics, Lyndonville, N.Y. The static sensor 75 is configured to sense the onset of static charge during drying of fabric articles in a fabric article drying appliance. One exemplary capacitive sensor has a range of about ±2 kV/cm and a sensitivity of about 1 V/cm. Another exemplary capacitive sensor has a range of about ±20 kV/cm and a sensitivity of about 10 V/cm. In a further embodiment, the static sensor 75 is configured to operate in an environment ranging in temperature of from about −30° C. to about 100° C. In another embodiment, the static sensor 75 is configured to operate in an environment ranging in relative humidity of from about 0% to about 85%.

FIG. 2 illustrates an exemplary fabric article treating device 20 according to one embodiment of the present invention. The fabric article treating device 20 comprises an interior dispenser 25 adapted for location inside of a fabric article drying appliance and a reservoir 30. The interior dispenser 25 and the reservoir 30 are adapted for fluid communication with one another, for example via fluid line 32. The reservoir 30 is adapted to contain a benefit composition. In one embodiment, the fluid connection between the interior dispenser 25 and the reservoir 30 comprises tubing configured to allow the benefit composition to be transported from the reservoir 30 to the interior dispenser 25. One exemplary tubing comprises a polymeric tubing with one or more channels or conduits. In one embodiment, the tubing is configured to allow a closure structure on the fabric article drying appliance to maintain a closed position while still permitting dispensing of the benefit composition, for example from the reservoir 30 located interior or exterior to the fabric article drying appliance. The fabric article treating device 20 further comprises a controller 60 and a static sensor 75 adapted for sensing static charge inside the fabric article drying appliance. The controller 60 is configured to initiate dispensing of the benefit composition when the static sensor 75 senses a predetermined amount of static charge. In one exemplary embodiment, the benefit composition comprises anti-static agent. For example, the benefit composition may comprise an electricity conducting composition. The electricity conduction composition will minimize the accumulated static charge detected by the static sensor 75. In another exemplary embodiment, the reservoir 30 is removable. In yet another exemplary embodiment, the reservoir 30 comprises a sealed pouch.

The reservoir 30 may be constructed of any material known in the art. Non-limiting examples of such materials include polymeric materials including, but not limited to, polypropylene, polyethylene, styrenics, polyesters, polyethylene terephthalate (PET), polycarbonates, PMMA, polyvinyls, Nylon, polyurethane, acrylic, epoxies, acetates, acrylonitrile-butadiene-styrene, fluoropolymers, latex, nitrile copolymers, nylons, polychloroprene, polyvinylchloride, Rayon, rubbers (natural and synthetic), silicone, and combinations thereof. Other exemplary materials of construction include metals, including aluminum foil. In one embodiment, the reservoir 30 comprises multiple layers of one or more materials. In another embodiment, the reservoir 30 comprises a single or multiple layer barrier film.

In another embodiment, as illustrated in FIG. 3, the fabric article treating device 20 comprises an air ionizer 27 adapted to dispense ionized air inside a fabric article drying appliance to quench a static charge, a controller 60 and a static sensor 75 adapted for sensing static charge inside the fabric article drying appliance. The controller 60 is configured to activate the air ionizer 27 when the static sensor 75 senses a predetermined amount of static charge. As one skilled in the art will appreciate, various air ionizers may be utilized in the present invention. For example, an air ionizer could be located exterior to the chamber of the fabric article drying appliance and the ionized air can be propelled with a blower or other means known to one skilled in the art. In another embodiment, the air ionizer is located within the interior of the fabric article drying appliance, such as the chamber. In one embodiment, the air ionizer comprises an ionizing bar. Air ionizing bars are commercially available from EXAIR Corp. of Cincinnati, Ohio. Other exemplary air ionizing units include, but are not limited to, ion air jets and ion air knives.

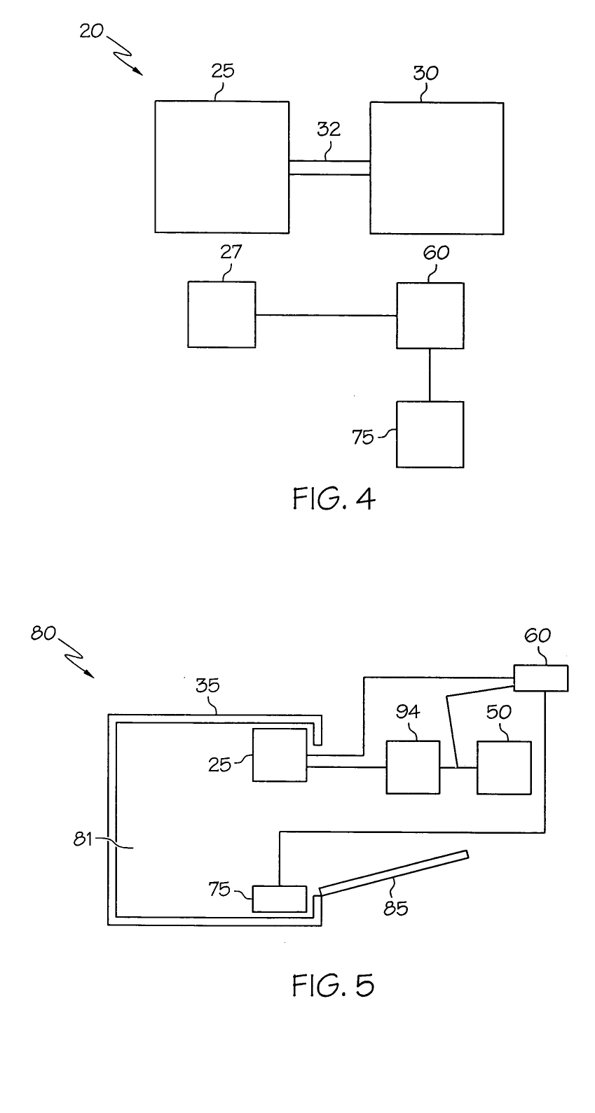

In another exemplary embodiment, as illustrated in FIG. 4, the fabric article treating device 20 of FIG. 3 further comprises an interior dispenser 25 adapted for location inside of the fabric article drying appliance, and a reservoir 30. The reservoir 30 is adapted to contain a benefit composition, and the reservoir 30 and the interior dispenser 25 are adapted for fluid communication with one another. In this embodiment, the fabric article treating device 20 is capable of dispensing a benefit composition in addition to ionized air from air ionizer 27, in order to further enhance the fabric articles being treated while minimizing the accumulation of static charge.

In another exemplary embodiment of the present invention, the reservoir 30 is adapted for location in an interior of the fabric article drying appliance 20. For example, the reservoir may be located in the chamber of the fabric article drying appliance. Alternatively, the reservoir may be located within the fabric article drying appliance, but not within the chamber of the fabric article drying appliance.

In the various embodiments disclosed herein, the interior dispenser 25 may comprise at least one nozzle for the purposes of distributing the anti-static agent and/or the benefit composition into the fabric article drying appliance. Misting/atomizing of the anti-static agent and/or the benefit composition can be achieved using any suitable spraying device such as a hydraulic nozzle, sonic nebulizer, pressure swirl atomizers, high pressure fog nozzle or the like to deliver target particle size. Non-limiting examples of suitable nozzles include nozzles commercially available from Spray Systems, Inc. of Pomona, Calif. under the Model Nos. 850, 1050, 1250, 1450 and 1650. Another suitable example of a nozzle is a pressure swirl atomizing nozzle made by Seaquist Perfect Dispensing of Cary, Ill. under Model No. DU-3813. In one exemplary embodiment, the nozzle may be configured to impart an electrical charge on the anti-static agent and/or the benefit composition being dispensed. In an alternative embodiment, the anti-static agent and/or benefit composition may be imparted with an electrical charge while in the reservoir.

Another embodiment of the present invention, as illustrated in FIG. 5, is a fabric article treating system 80. The fabric article treating system 80 comprises a fabric article drying appliance 35 having a chamber 81 and a closure structure 85, for example, a door. The closure structure 85 has a closed position and at least one open position. The closure structure 85 allows access to the chamber 81 of the fabric article drying appliance 35. The fabric article treating system 80 further comprises a dispenser 25 in communication with the chamber 81; a static sensor 75 in the chamber 81; and a controller 60 configured to initiate dispensing of anti-static agent when the static sensor 75 senses a predetermined amount of static charge. In one exemplary embodiment, the anti-static agent comprises an electricity conducting composition. In a further embodiment of the present invention, the fabric article treating system 80 further comprises a charging circuit 94 that imparts an electrical charge to the anti-static agent, thereby generating an electrostatic spray. In this embodiment, the fabric article treating system may comprise a power source 50. The power source 50 maybe utilized to power the controller 60, and the static sensor 75, and can be used to electrically charge the anti-static agent that will be dispensed though the dispenser 25. As noted above, electrical charge may be imparted to the anti-static agent and/or the benefit composition while in the reservoir 30 or while being dispensed through the dispenser 25.

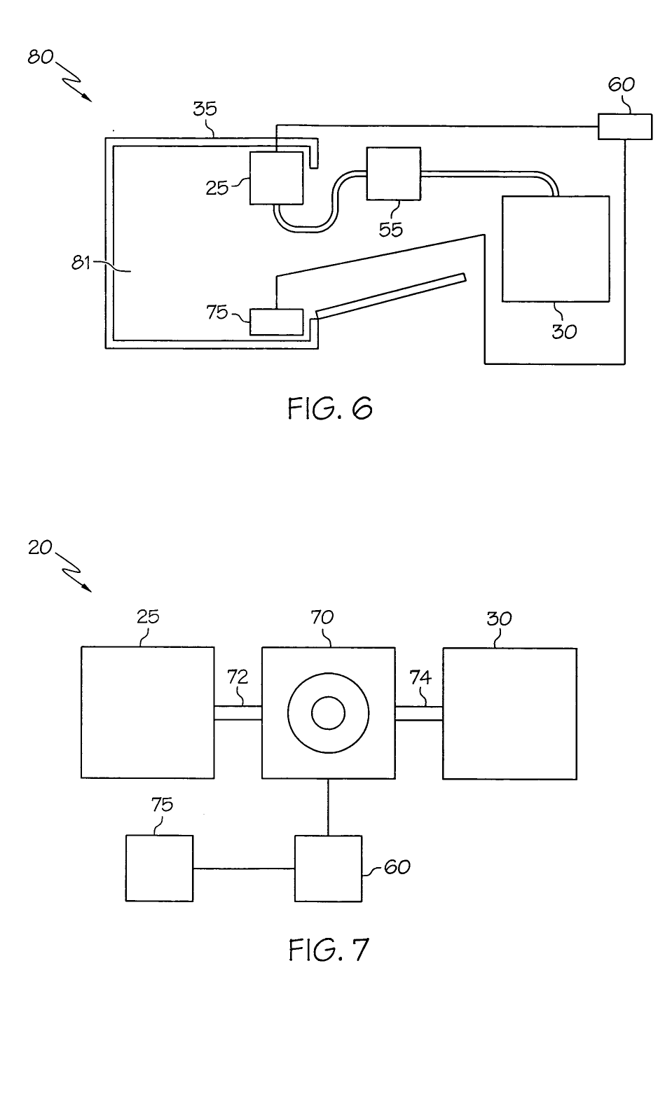

In one exemplary embodiment as illustrated in FIG. 6, the fabric article treating system 80 further comprises a reservoir 30 adapted to contain a benefit composition, and a fluid handling system 55 that compels the benefit composition from the reservoir 30 toward the dispenser 25, thereby dispensing the benefit composition into the chamber 81. In a further embodiment, the controller 60 is adapted to initiate dispensing of the benefit composition. For example, the controller 60 may determine optimum time, amount of composition and the rate at which to dispense the anti-static agent and benefit composition into the chamber 81 of the fabric article drying appliance 35.

In one exemplary embodiment, as illustrated in FIG. 7, the fluid handling system 55 further comprises a pump 70. The pump 70 is in communication with the reservoir 30 and the interior dispenser 25 via fluid lines 72 and 74, respectively. The pump 70 is configured to transport anti-static agent and/or a benefit composition from the reservoir 30 to the interior dispenser 25 for dispensing of the compositions into the interior of a fabric article drying appliance. In one embodiment, the pump 70, comprises a piezo-electric pump. In another embodiment, the pump 70 may comprise a diaphragm pump. As one skilled in the art will appreciate, any pump known to one skilled in the art may be utilized to transport the anti-static agent and/or the benefit composition from the reservoir 30 to the interior dispenser 25. Other exemplary pumps include piston pumps, peristaltic pumps, and bellows-type pumps.

As noted above, one type of pump 70 that can be used in the present invention is a piezo-electric pump. While a piezo-electric pump has certain membranes or laminations which may vibrate in a reciprocating-type fashion, the piezo-electric pumps generally do not have major moving parts, such as rotating shaft and bearings used with a rotator member to displace a fluid or gaseous fluid, that experience wear over time. One commercially available suitable piezo pump usable in the present invention is manufactured by PAR Technologies, LLC, located in Hampton, Virginia, and marketed as the “LPD-Series” laminated piezo fluid pumps. Pumps which draw a relevantly low current are particularly suitable in certain embodiments.

In another embodiment, the reservoir 30 may be positioned in such a way to provide gravitation flow of the benefit composition to the interior dispenser 25. For example, the reservoir 30 may be mounted above the fabric article drying appliance to create static head on the benefit composition to allow dispensing of the anti-static agent and/or the benefit composition without the utilization of a pump.

The reservoir 30 may be mounted on the exterior surface of the fabric article drying appliance 35, such as on the fabric article drying appliance closure structure 85, or a side wall, a top wall, an outer surface of a top-opening lid, or the like, including a stand, wall or other household structure that is separate from the fabric article drying appliance. Moreover, the reservoir 30 may be mounted on any interior surface of the fabric article drying appliance 35, examples of which include, but are not limited to, the interior surface of the closure structure 85, the drum of the fabric article drying appliance, the back wall, the inner surface of a top opening lid, or the like.

Optionally, filters and/or filtering techniques can be used to filter the benefit composition, if desired, for example at a point between the reservoir 30 and the outlet of the dispenser 25. Non-limiting examples of this include: utilizing a filter in the interior dispenser 25 prior to dispensing of the benefit compositions. Alternatively, the benefit composition may be filtered prior to dispensing into the reservoir; or a combination of filtering techniques may be employed.

The interior dispenser 25 and the reservoir 30 are adapted for fluid communication with one another. In one embodiment, the interior dispenser 25 and the reservoir 30 may be in electrical connection to one another. Non-limiting examples of connecting the interior dispenser 25 and the reservoir 30 may include utilizing a flat cable (also referred to as a ribbon cable), a wire, a wire or group of wires enclosed in a sheath of woven or nonwoven material, a conduit (a non-limiting example of which is a conduit for the benefit composition), or combination thereof. The woven or nonwoven sheath may be used as a method of attaching the interior dispenser 25 and the reservoir 30. The interior dispenser 25 and the reservoir 30 may be used to provide a means of gravitational counterbalancing so as to reduce unnecessary tension on the wires and/or the connections.

The power source 50 may comprise chemical batteries, or any electrical power source, including standard household line voltage, or even solar power. Batteries may be utilized, and are particularly suitable when the fabric article treating device 20 is in the form of an add-on device for an existing fabric article drying appliance 35. However, any appropriate power adapter can be provided to convert an AC power source to the appropriate DC voltages used in any electrical components of the fabric article treating device 20, such as in the fluid handling system 55, the controller 60, and any sensors 75.

As noted, the fabric article treating device 20 can include, in addition to a static sensor 75, one or more optional sensors. Non-limiting examples of optional sensors include a door (or lid) sensor, a motion sensor, a humidity sensor, and/or a temperature sensor. One non-limiting example of a door/lid sensor is an optoelectronic device, such as an optocoupler or an optical input sensor, e.g., a phototransistor or photodiode. When the door/lid of the drying appliance is open, the door sensor will change state, and will output a different voltage or current level along an electrical conductor that leads from the door sensor back to the controller. This can be used as a safety device to immediately interrupt the dispensing of the benefit composition from the interior dispenser 25. The optional door sensor could be utilized even when a control system is integrated into the overall conventional control system of the drying appliance. For example, a drying appliance typically has its own door sensor which shuts off the rotating drum of the dryer when the door becomes open. In this instance, the optional door sensor can act as a backup or second door sensor to the dryer's internal original sensor that shuts off the rotating drum. One example which could be used as a door/lid sensor is an NPN Phototransistor, Part No. PNA1801L, manufactured by Panasonic, of Osaka, Japan. In another embodiment, a communication link could be established between the drying appliance and the controller, wherein the drying appliance would send the controller a signal relating to the operational state of the drying appliance (e.g., door open/closed, drying cycle, temperature, etc.).

Another type of optional sensor that can be utilized by the fabric article treating device 20 of the present invention is a motion sensor. For fabric article drying appliances 35 which utilize a moving interior, such as a rotating drum, the motion sensor can detect if a fabric article drying appliance is in use. One example of a motion sensor is a vibration and movement sensing switch manufactured by ASSEM Tech Europe Ltd., of Clifton, N.J., available as Model No. CW1600-3. Another type of optional motion sensor that may be used in the present invention uses a light source to direct (infrared) light at a surface, and the relevant motion of that surface can be detected by the intensity and/or frequency of the returning light. Such sensors can measure the actual speed of rotation, if that information is desired.

Another optional sensor that can be used in a fabric article treating device 20 of the present invention is a humidity sensor. The optional humidity sensor, together with the controller, may be used together with the static sensor to control the amount of anti-static agent, and/or alone or together with the static sensor to control the amount of benefit composition being dispensed by the interior dispenser 25, and also may be utilized to determine the proper environmental conditions during an operational cycle in which the dispensing event should take place. Additionally, this humidity sensor may be used to maintain a specific humidity by controlling the dispensing the benefit composition such that optimal de-wrinkling and/or other benefits are achieved. Many different types of humidity sensors could be used in conjunction with the present invention, including variable conductivity sensors. One such sensor is manufactured by Honeywell, of Freeport, Ill. under the Model No. HIH-3610-001, although any of the HIH-3610 series may be used.

A further optional sensor that can be useful in the fabric article treating device 20 of the present invention is a temperature sensor, such as one that outputs an analog or digital signal along the electrical conductor that leads back to the controller.

As noted above, the fabric article treating device 20 comprises a controller 60. In one embodiment, the controller may be a microcontroller. A suitable microcontroller is manufactured by MicroChip, of Chandler, Ariz. under the Part No. PIC16LS876-04/P. However, other microcontrollers made by different manufacturers could also easily be used. In one exemplary embodiment, the microcontroller includes on-board random access memory (RAM), on-board read only memory (ROM), which comprises electrically programmable non-volatile memory elements, as well as on-board input and output lines for analog and digital signals. The controller may also be used with a crystal clock oscillator, although a RC circuit could be used instead as a clock circuit, if desired. The clock circuit provides the timing of the clock as necessary to operate the controller. In one embodiment, the controller comprises a port that can be interfaced to an optional programmable interface using a communication link, such as RS-232 communication link. The port allows a user to alter the program information of the controller, such as dispensing options, etc.

One skilled in the art will appreciate that the controller can be any type of microprocessor or microcontroller circuit commercially available, either with or without on-board RAM, RAM, or digital and analog input/output (IVO). Moreover, a sequential processor may be used to control the fabric article treating device 20, or alternatively a parallel processor architecture or a logic state machine architecture could be used. Furthermore, the controller 60 may be integrated into an Application Specific Integrated Circuit (ASIC) containing many other logic elements that could be used for various functions, as desired, such functions being optional depending upon the model of the fabric article treating device 20 that will be sold to a consumer. To change model features, the manufacturer need only program the ASIC or the on-board RAM of the controller according to the special parameters of that particular model, while using the same hardware for each of the units.

It will also be understood that discrete digital logic could be used instead of any type of microprocessor microcontroller unit, or analog control circuitry could be used along with voltage comparators and analog timers, to control the timing events and to make decisions based on input levels of the various sensors that are provided with the fabric article treating device 20.

It will be understood that the present invention can be readily used in other types of fabric “treating” devices, and is not limited solely to clothes “dryers”. In the context of this patent document, the terms “dryer” or “drying apparatus” or “fabric article drying appliance” include devices that may or may not perform a true drying function, but may involve treating fabric without attempting to literally dry the fabric itself. As noted above, the terms “dryer” or “drying apparatus” or “fabric article drying appliance” may include a “dry cleaning” process or apparatus, which may or may not literally involve a step of drying. The term “fabric article drying appliance” as used herein, also refers to any fabric treating device that utilizes moving air directed upon one or more fabric articles, a non-limiting example of which includes a clothes dryer, and modifications thereof. Such devices include both domestic and commercial drying units used in dwellings, laundromats, hotels, and/or industrial settings. In addition, it should be noted that some drying appliances include a drying chamber (or “drum”) that does not literally move or rotate while the drying appliance is operating in the drying cycle. Some such dryers use moving air that passes through the drying chamber, and the chamber does not move while the drying cycle occurs. Such an example dryer has a door or other type of access cover that allows a person to insert the clothing to be dried into the chamber. In many cases, the person hangs the clothes on some type of upper rod within the drying chamber. Once that has been done, the door (or access cover) is closed, and the dryer can begin its drying function. Dispensing of a benefit composition can take place within such a unit, however, care should be taken to ensure that the benefit composition becomes well dispersed within the drying chamber, so that certain fabric items do not receive a very large concentration of the benefit composition while other fabric items receive very little of the benefit composition.

Exemplary fabric article treating devices and systems includes those described in co-pending U.S. application Ser. No. 10/697,735 filed on Oct. 29, 2003; U.S. application Ser. No. 10/697,685 filed on Oct. 29, 2003; U.S. application Ser. No. 10/697,734 filed on Oct. 29, 2003; U.S. application Ser. No. 10/697,736 filed on Oct. 29, 2003; and U.S. application Ser. No. 10/762,152 filed on 10/762,152.

All documents cited in the detailed description of the invention are, in relevant part, incorporated herein by reference; a citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A fabric article treating device, comprising:
an interior dispenser adapted for location inside of a fabric article drying appliance;
a controller; and
a static sensor adapted for sensing static charge inside the fabric article drying appliance;
wherein the controller is configured to initiate dispensing of anti-static agent when the static sensor senses a predetermined amount of static charge.

2. A fabric article treating device, comprising:
an interior dispenser adapted for location inside of a fabric article drying appliance;
a reservoir adapted to contain a benefit composition, wherein the interior dispenser and the reservoir are adapted for fluid communication with one another;
a controller; and
a static sensor adapted for sensing static charge inside the fabric article drying appliance;
wherein the controller is configured to initiate dispensing of the benefit composition when the static sensor senses a predetermined amount of static charge.

3. The fabric article treating device of claim 2, wherein the static sensor comprises a capacitive sensor.

4. The fabric article treating device of claim 2, wherein the benefit composition comprises anti-static agent.

5. The fabric article treating device of claim 4, wherein the anti-static agent comprises an electricity conducting composition.

6. The fabric article treating device of claim 4, wherein the anti-static agent comprises a solvent-soluble electricity conducting polymer.

7. The fabric article treating device of claim 3, wherein the capacitive sensor is adapted to have a range of from about −2 kV/cm to about 2 kV/cm and have a sensitivity of about 1 V/cm.

8. The fabric article treating device of claim 3, wherein the capacitive sensor is adapted to have a range of from about −20 kV/cm to about 20 kV/cm and have a sensitivity of about 10 V/cm.

9. A fabric article treating device, comprising:
an air ionizer adapted to dispense ionized air inside a fabric article drying appliance to quench a static charge;
a controller; and
a static sensor adapted for sensing static charge inside the fabric article drying appliance;
wherein the controller is configured to activate the air ionizer when the static sensor senses a predetermined amount of static charge.

10. The fabric article treating device of claim 9, wherein the air ionizer comprises an ionizing bar.

11. The fabric article treating device of claim 9, wherein the air ionizer comprises an ion air jet.

12. The fabric article treating device of claim 9, further comprising:
an interior dispenser adapted for location inside of the fabric article drying appliance;
a reservoir adapted to contain a benefit composition, wherein the interior dispenser and the reservoir are adapted for fluid communication with one another.

13. A fabric article treating system, comprising:
a fabric article drying appliance having a chamber and a closure structure, the closure structure having a closed position and at least one open position, the closure structure allowing access to the chamber;
a dispenser in communication with the chamber;
a static sensor in the chamber; and
a controller configured to initiate dispensing of anti-static agent when the static sensor senses a predetermined amount of static charge.

14. The fabric article treating system of claim 13, wherein the anti-static agent comprises an electricity conducting composition.

15. The fabric article treating system of claim 14, further comprising a charging circuit that imparts an electrical charge to the anti-static agent, thereby generating an electrostatic spray.

16. The fabric article treating system of claim 14, wherein the static sensor comprises a capacitive sensor.

17. The fabric article treating system of claim 13, further comprising:
a reservoir adapted to contain a benefit composition including the anti-static agent; and
a fluid handling system that compels the benefit composition from the reservoir toward the dispenser, thereby dispensing the benefit composition into the chamber.

18. The fabric article treating system of claim 14, wherein the electricity conductive composition comprises one or more polymers selected from the group consisting of polyanilines, polypyrroles, polyacetylene, polyphenylene, and polythiophene.

19. The fabric article treating system of claim 17, wherein the benefit composition comprises one or more components selected from the group consisting of: fabric softeners, superwetting agents, water absorbing agents, humectants, preservatives, buffering agents, hueing agents, perfumes, lubricants, anti-abrasion agents, wrinkle-mitigating agents, pH adjusting agents, emulsion stabilizing agents, malodor control agents, oil dispersing solvents, anti-foaming agents, salt, viscosity adjusting agents, chelating agents, anti-oxidants, radical scavenging agents, soil releasing agents, anti-soiling agents, and anti-bacterial agents.

20. The fabric article treating system of claim 13, wherein the reservoir comprises a pouch.
